(19) United States
(12) Patent Application Publication
(10) Pub. No.: US 2015/0186601 A1
(43) Pub. Date: Jul. 2, 2015

(54) Systems and Methods for Hospital Bed Management

(71) Applicant: Michael J. Waxman, Leawood, KS (US)

(72) Inventor: Michael J. Waxman, Leawood, KS (US)

(21) Appl. No.: 14/319,674

(22) Filed: Jun. 30, 2014

Related U.S. Application Data
(60) Provisional application No. 61/921,279, filed on Dec. 27, 2013.

(51) Int. Cl. G06F 19/00

(52) U.S. Cl. CPC G06F 19/322; G06F 19/3406

(57) ABSTRACT

One automated bed-management system for healthcare facilities includes multiple patient identification and location transponders, a location system for identifying locations of each transponder within a facility, and at least one processor having in a memory system a facility map database, a transponder-to-patient identification database, and a bed-assignment database. Machine readable code resides in memory for mining an electronic medical record (EMR) system database for data associated with patients associated with patient identification transponders. Machine readable code is also in memory for automatically determining an appropriate category of bed assignment for the at least one patient based upon data mined from the EMR system database.

### RELATED APPLICATION

This application claims priority to U.S. Provisional Patent Application 61/921,279 filed 27 Dec. 2013, the entire contents of which are incorporated herein by reference.

### BACKGROUND

Electronic tracking tags have been proposed for use in tracking locations of both patients and equipment in a hospital setting. These are typically based on infrared or low-powered radio Loran-type technologies because GPS signals may not penetrate throughout a multistory hospital; systems using infrared technologies typically have multiple infrared location reference devices located at multiple locations throughout a facility so that equipment is within range of a reference device at all times. Among such device and location systems is the CENTRAK® (Trademark of Cen Trak Inc., Newton, Pa.) locator system www.centrak.com). Other patient and equipment locator systems are also known in the art.

While Centrak and similar systems are adapted to determine where patients and equipment are located in a hospital, these systems typically do not interact with an electronic medical records (EMR) database system, and typically are not integrated into a bed management and allocation system.

Many healthcare facilities have beds or other locations where patients may be located of many different types, often scattered throughout a large facility. A bed in an intensive-care unit (ICU) is often provided with more nursing staff, and more equipment, than a bed on a general medicine ward; the additional training and equipment make the ICU beds more expensive to operate than general medical beds. Other hospitals may have a mix of psychiatric beds of locked-unit and unlocked-unit types, as well as general medical beds; patients are often resentful of being in locked facilities when an unlocked facility is more appropriate. Further, training and responsibilities of ICU staff is often well in advance of staff in a general medicine ward.

Many healthcare facilities also are often fully-booked, with few beds of any particular type being empty. When all beds of a particular type are filled, it may be necessary to send patients to other facilities, put patients in a more expensive bed type than appropriate for their needs, or otherwise improvise. Similarly to hotels, last night's empty bed is an expensive waste of resources, particularly if full nursing staff is assigned to that bed.

It is desirable to manage bed assignments such that patients are assigned a bed appropriate for their needs.

### SUMMARY

The following presents a simplified summary in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

In one embodiment, an automated bed-management system for healthcare facilities includes multiple patient identification and location transponders, a location system for identifying locations of each transponder within a facility, and at least one processor having in a memory system a facility map database, a transponder-to-patient identification database, and a bed-assignment database. Resident in memory is machine readable code for mining an electronic medical record (EMR) system database for data associated with patients associated with patient identification transponders. Also in memory is machine readable code for automatically determining an appropriate category of bed assignment for the at least one patient based upon data mined from the electronic medical record.

In another embodiment, an automated bed-management system is provided for healthcare facilities having a plurality of beds and a plurality of patients. The system includes a plurality of patient identification and location transponders; a location system for identifying a current location of each transponder; at least one processor having in a memory system a facility map database, a transponder-to-patient identification database, and a bed-assignment database. Machine readable code is further provided for: (a) mining an EMR system database for data associated with the patients; (b) automatically assigning an appropriate category of bed for each of the patients based upon data mined from the EMR system database; (c) correlating in a one-to-one manner the transponders to the beds using the transponder-to-patient identification database and the bed-assignment database; (d) identifying each of the transponders that is more than a predetermined distance from its respective correlated bed; and (e) outputting an alert for each transponder identified in (d). Each alert in (e) includes patient identification information, a current patient location, and an assigned patient location.

In still another embodiment, a method of automated bed management for use in healthcare facilities includes the steps: (a) applying a patient transponder to each patient, each transponder having a unique identity; (b) locating patient transponders within a healthcare facility using a transponder locating system; (c) using machine readable code executed on at least one processor to query a transponder-to-patient identification database to identify at least one patient associated with a located patient transponder; and (d) using machine readable code to mine an EMR system database for data associated with the at least one patient and to automatically assign an appropriate category of bed for the at least one patient based upon the data mined from the EMR system database.

### BRIEF DESCRIPTION OF THE FIGURES

FIG. 1 is a schematic block diagram of a healthcare-facility patient tracking and bed management system.

FIG. 2 is a flowchart of typical operations in managing assignment of patients to beds in a healthcare facility.

FIG. 3 is a facility schematic with patient icons.

### DETAILED DESCRIPTION OF THE EMBODIMENTS

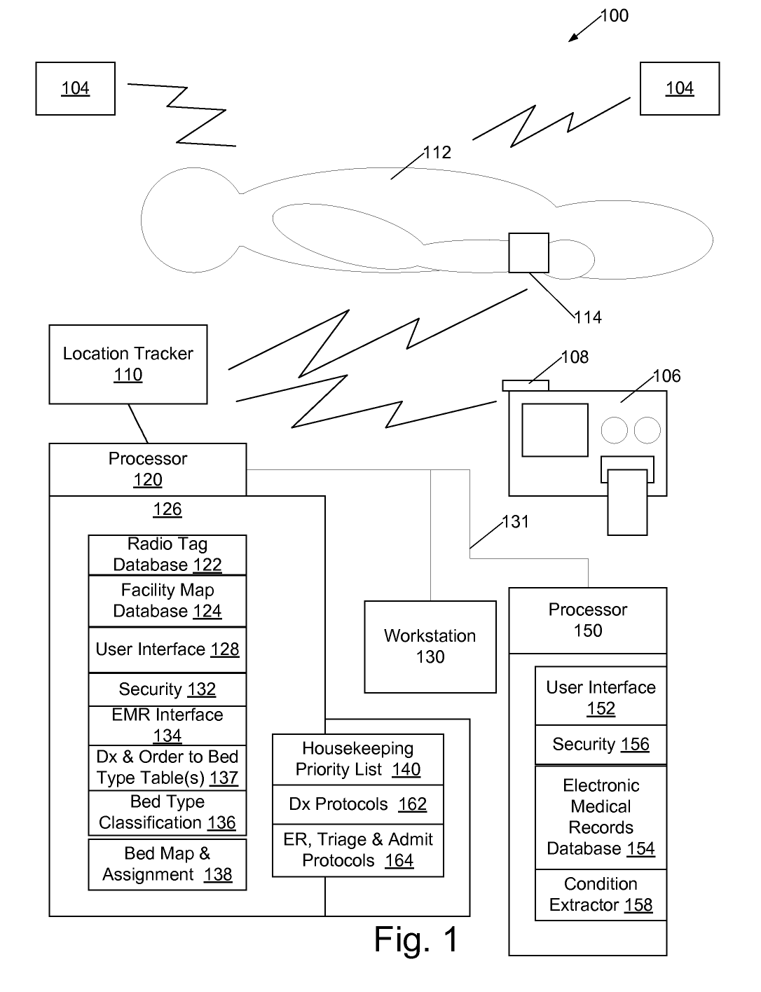

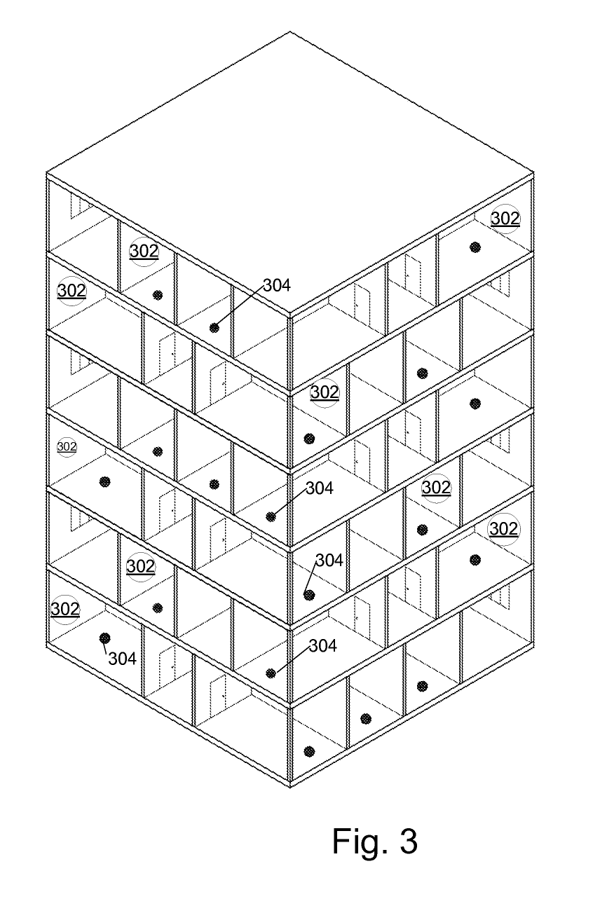

A healthcare facility has a number of rooms and hallways, each of which is equipped with one or more location reference beacons 104 (FIG. 1), 302 (FIG. 3), each of which transmits its identification and a time-reference as a signal by infrared light or by radio. The facility may have one, two, or more floors; multistory facilities typically have beacons 104 on two or more floors. High-value portable equipment, such as portable cardiac monitor 106, is equipped with a locator transponder 108 that receives signals from reference beacons 104, and transmits information derived from signals transmitted by the reference beacons to a locator system 110, typically by short-range radio. In some, but not all, systems, the transponders operate over 802.11-series “Wi-Fi” networks.

The locator system 110 uses known coordinates of reference beacons 104, 304 and differences in timing of signals from multiple beacons as they are received at transponders 108, to determine a coordinate of each transponder. Since beacons are on two or more floors, the system can resolve transponder locations in three dimensions, at least to the room and floor level, and in some embodiments to within a few inches.

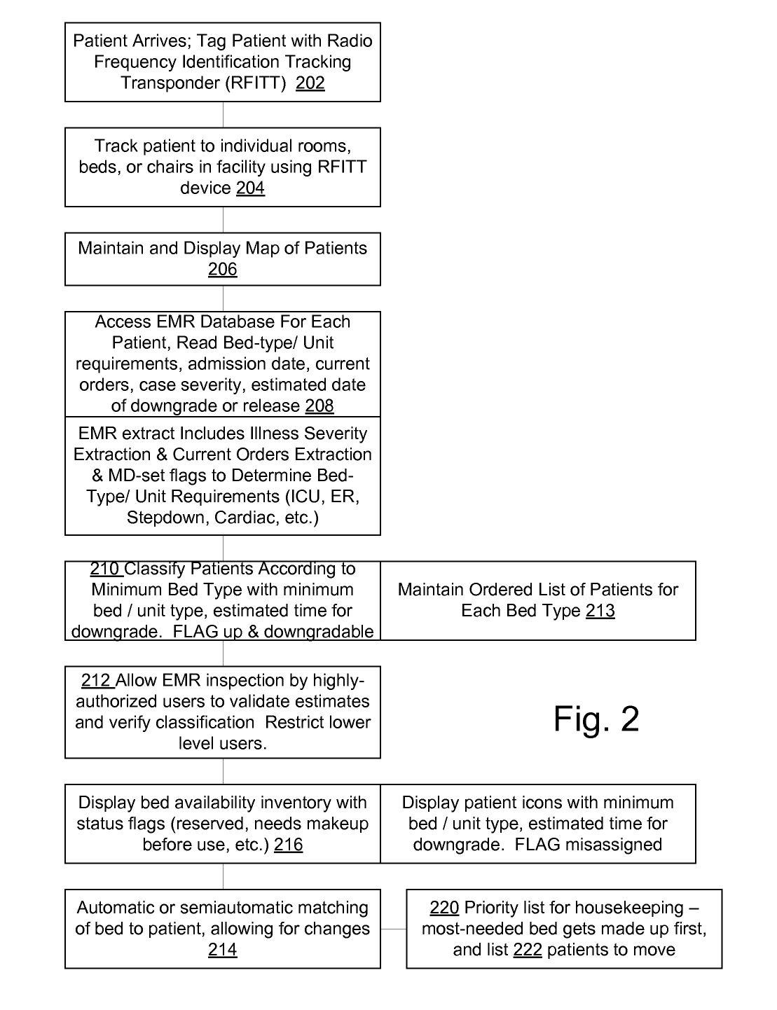

In an embodiment, each of multiple patients 112 are also tagged 202 (FIG. 2) with a transponder 114, 304 on arrival at the facility which they are requested to wear—typically but not always on a wrist—for the duration of their stay within the facility; the locator system determines coordinates for transponders 114 worn by patients in addition to determining coordinates of transponders attached to equipment or patients. Locator system 110 reports coordinates of all active transponders reporting to it, and transponder identification codes, to a processor 120. These coordinates have sufficient resolution to track 204 a patient to an individual bed, chair, or room in the facility.

Processor 120 maintains a radio tag database 122 in memory 126. The processor 120 executes machine readable code from memory 126 to identify each reporting transponder in the database from the transponder identification codes; for patient transponders, the radio tag database 122 provides a patient name and identification number.

Processor 120 also maintains a facility map database 124 in memory 126 having recorded therein a map of the facility to at least a patient room level, and preferably to a level of individual beds within those rooms. In an embodiment, the map has the form of a reconstruction of the medical center's physical plant, presented in moveable 3D CAD type representation. Processor 120 executes machine readable code from memory 126 to locate each reporting transponder on this map database. The processor also executes a user interface code 128 that provides for displaying information from the map database with icons representing patients and equipment locations on a workstation 130; typical systems may have dozens of workstations interconnected by a network 131 to processor 120. At a basic level of user authorization, users at workstation 130 may access the map database to display 206 locations of particular types of equipment, of in-use equipment or not-in-use equipment, and locations and names of patients within a particular unit. Processor 120 also executes security code 132 to determine a level of authorization of the user. At a second level of authorization, users at workstation 130 may access and display locations of equipment, and locations and names of patients, throughout the facility. In an embodiment, this data is displayed when users click on, expand, or enter an icon representing a patient location.

Periodically, processor 120 executes an Electronic Medical Records (EMR) interface routine 134 to access an electronic health record 154 maintained by a second processor 150. Processor 150 has user-interface code 152 that permits users at workstation 130 to access patient records of the electronic health record 154 as authorized by security system software 156. EMR has an automatic patient condition extraction facility 158 that estimates condition, or illness severity, of each patient based upon factors in the patient's medical record.

In an embodiment, diagnosis-related protocols 162, and emergency room and/or admission protocols 164 are also stored in memory 126.

When accessing the EMR, Processor 120 reads 208 bed-type and unit requirements from the EMR if there are any specific physician orders for bed type, as well as mining the EMR database for current orders. The current orders are automatically screened for orders that limit the patient to any particular type of bed, such as ventilator orders, cardiac monitor orders, sedation, test orders, and the like. Criteria for screening orders may be set for a particular facility. Also read from the EMR are the illness severity extracted from the EMR, as well as patient diagnosis, admission date, and any expected release date or stepdown date that has been entered into the EMR. Further, any recent procedures are identified, and if they are of a type that has a bed restriction associated with it (for example, a surgical procedure involving general anesthetic may restrict a patient to a recovery room bed or ICU bed for some hours), that restriction is taken into account. The processor 120 executes a bed type classification 136 routine using this information and classifies patients according a bed type requirement. The processor also determines a point score for ranking patients within a bed type classification. An ordered list of patients within a bed type classification, sorted by point score, is maintained 212 by the processor 120, with those patients most likely to benefit from an upgrade at the top of the list, and those subject to possible downgrade at the bottom of the list. These lists, together with lists of vacant beds of each bed type, are made available to a user who may then assign an incoming patient to a particular bed.

As part of classifying patients according to a bed type requirement, orders extracted from the EMR for each patient are looked up in a diagnosis and order-to-bed type table 137 or tables located in memory 126, listing orders permitted in each bed type for that diagnosis. Since medical facilities may vary (indeed some have multiple types of specialized intensive care units (ICU) and stepdown units, while others may have a single ICU and no stepdown unit, and others may permit more order types on general wards than others), an exemplary portion of such a table, including diagnosis as well as orders, but not a limiting example, is as follows:

TABLE 1
Exemplary Diagnosis and Order to Bed-type Table

| | | | | General | Release to |
|---|---|---|---|---|---|
| Diagnosis | Order | ICU | Stepdown | ward | Home |
| Pneumonia | Intubated | Y | | | |
| | Trach & Vent | Y | Y | | |
| | Oxygen Mask | Y | | | |
| | FiO2 >0.5 | | | | |
| | Oxygen Mask | Y | Y | | |
| | FiO2 0.35-0.5 | | | | |
| | Oxygen Mask | Y | Y | Y | |
| | FiO2 <0.35 | | | | |
| | Oxygen Cannula | Y | Y | Y | Y |
| | to 4 liters | | | | |
| | IV antibiotic | Y | Y | Y | Y nurse |
| | Oral Antibiotic | Y | Y | Y | Y |

In an alternative embodiment, patient EMRs are mined for recent procedure-related orders, for recent and active medication-related orders, and for diagnoses. After patient records are mined for procedure-related orders, those procedures are looked-up in a procedure-order to bed-type table located in memory 126 of processor 120. Each of certain procedures, until reversed, restricts the patient to particular bed types. For example, as illustrated in Table 2, insertion of an endotracheal tube may restrict a patient to an intensive-care unit (ICU) until it is removed, since such tubes generally are associated with ventilators and typical medical-surgical wards (Med Surg) are not equipped to handle such patients.

TABLE 2
Exemplary procedure to bed-type table

| PROCEDURE | ICU | PCU | Tele | Med Surg |
|---|---|---|---|---|
| Insert Endotracheal Tube | X | | | |
| Tracheostomy | X | X | | |
| Mechanical Ventilator | X | X | | |
| Swan Ganz Catheter | X | | | |
| Arterial Line | X | | | |
| Trauma introducer | X | X | | |
| NPPV other than stable sleep Rx | X | X | | |
| NPPV for stable sleep Rx | X | X | X | X |
| PEEP on mechanical ventilator >5 | X | | | |

Similarly, in an embodiment, after patient records are mined for medication-related orders, or prescriptions, those orders are looked-up in a medication-order to bed-type table located in memory 126 of processor 120. Each of certain medications, until cancelled or, for single-dose medications, worn off, restricts the patient to particular bed types. Since an individual patient may have several unexpired or recently-administered medication-related orders, a most-restrictive bed type is determined from bed type restrictions found in the table. For example, as illustrated in Table 3, administration of a fibrinolytic, such as tissue plasminogen activator (TPA) or streptokinase, both occasionally used in occlusive stroke and myocardial infarction patients, may restrict a patient to an intensive care unit for a predetermined amount of time since such patients require monitoring for hemorrhage in a way that lesser wards are not equipped for; and vasodilator drips require frequent checking of blood pressure.

TABLE 3
Exemplary Medication Order to Bed-Type Table

| MEDICATION | ICU | PCU | Tele | Med Surg |
|---|---|---|---|---|
| Fibrinolytic Rx, e.g. TPA | X | | | |
| Intravenous Vasopressor | X | | | |
| Intravenous Vasodilator Drip | X | | | |
| Antihypertensive Drip | X | X | | |
| FiO2 > 6Ln/c, less than FiO2 0.6 | X | X | | |
| FiO2 greater than or equal to 0.6 | X | | | |

Similarly, in an embodiment, after patient records are mined for diagnoses, those diagnoses, of which there may be more than one, are looked-up in a diagnosis to bed-type table located in memory 126 of processor 120. Each of certain diagnoses, for a time, restricts the patient to particular bed types. Since an individual patient may have several diagnoses, a most-restrictive bed type is determined from bed type restrictions found in the table. For example, as illustrated in Table 4, administration a diagnosis of myocardial infarction may restrict a patient to an intensive care unit, stepdown unit (PCU), or telemetry-monitoring unit (Tele) for a predetermined amount of time since such patients are subject to potentially life-threatening arrhythmias that these units are able to monitor for, while many standard medical-surgical units are not equipped to properly monitor these patients.

TABLE 4
Diagnosis to bed-type table

| Diagnosis | ICU | PCU | Tele | Med Surg |
|---|---|---|---|---|
| Shock | X | | | |
| ARDS | X | | | |
| Acute Stroke first 24 hrs | X | | | |
| Acute Respiratory Failure | X | X | | |
| Hypertensive Emergency | X | | | |
| Hypertensive Urgency | X | X | | |
| Acute Myocardial Infarction | X | X | X | |
| Imminent risk of intubation | X | | | |
| Hemodynamic instability | X | | | |
| Life threatening arrhythmia | X | | | |
| Unstable metabolic/endocrine | X | X | | |
| Neuro/Trauma GCS 9 or less | X | | | |
| Neuro/Trauma GCS >9 | X | X | | |

Also in memory 126 of processor 120 is a bed assignment database 138, having a record for each bed of each type in the facility. The bed records are linked to patient records for patients assigned to that bed. In some embodiments, the locations and identities of patients identified by transponders is compared to nearest bed locations and verified against a patient assigned to that bed to determine if patients are misplaced. Also, the bed type classification for that patient is compared to the type of the assigned bed and patients assigned to an inappropriate bed are flagged on a display and subjected to reassignment 214.

When a bed is listed in the bed assignment database and no transponder is near that bed, the current location of the assigned patient is identified. A user may then determine if the assignment database is in error, such as may happen if the patient has left the facility, been released, or moved, and correct the error. While doing so, the user may view the patient's current location on the facility map database, to determine if the patient is located in a part of the facility that is frequently used temporarily by patients, such as physical therapy rooms, X-ray rooms, treatment rooms, operating rooms, bathrooms, or similar rooms. If a patient is found in such a location, the system presumes that the bed must still be reserved for that patient.

High security level users may access 216 all data extracted from the EMR database, and the EMR database through processor 120 and processor 150, to validate, and change when necessary, bed classification and point score. The user may click into details of information of a patient's problem list and retain portions on screen while entering or “clicking into” other items. For example, lab results, such as arterial blood gasses of pneumonia patients, can be double clicked to remain along a margin while the investigator views other patient information, such as other labs or X-rays. Current laboratory could remain along a margin while the user accessed orders, to determine for example what level of oxygen a patient was on when the blood gas was drawn.

Further, a user may access the ordered list of patients within a bed type to determine which patients should be relocated to better meet patient requirements. The user may then display 218 bed inventory and status, and either automatically or manually reassign 214 patients to different beds according to the needs of both the patient and of other patients in the facility. The user may also display bed inventory and status, as well as bed category assignment for a patient, and assign a particular bed to the patient in a bed assignment database 138.

The bed assignment database 138 includes fields to indicate beds that are currently unoccupied, but are not yet prepared for a new patient to be assigned to them. A prioritized list of room makeup and bed cleanings is prepared 220 for housekeeping. A list of patients to move is also prepared 222.

Just as patient icons can be entered or enlarged to show patient specific information, so can parts of the medical center be enlarged to show sections of the physical plant and patients who are resident at those locations. This allows the user to visualize an area such as the intensive care unit or the emergency department to see how many and where patients are located. Options for patient information allow the manager to see certain patient demographics such as visualizing all patients and their primary diagnoses or age or length of stay or any variable that can be data mined; patient icons on the map may be color coded according to particular variables, and icon shape coded according to other variables. Single or groups of variables can be visualized according to user request. For example, icons representing patients in an emergency room unit that have not been triaged can be color coded red, while those who have been triaged and are expected to be released after treatment in the ER coded blue, those expected to be admitted to other units of the facility coded in yellow, and those being seen for minor ailments coded in green. A user can then click into, or expand, the yellow icons representing patients to be admitted to review EMR data associated with those patients before assigning them to appropriate beds in the facility.

In an embodiment, when units in an emergency room (ER) or other reception unit are viewed by a user, the EMR for each patient in that unit is mined for diagnoses, orders for medications, and procedures that have been prescribed or performed in the ER or reception unit, together with patient demographic information such as age and sex. The user may view this information for each patient directly, so as to place patients with roommates of the same sex, and to divert children to an appropriate pediatric unit. The system uses mined diagnoses, and mined orders for medication, and procedures, to recommend an appropriate unit to which the patient should be transferred when stable, and to flag those patients requiring transfer to a procedure room, such as an operating room or catheterization room, before subsequent transfer to the appropriate unit.

In an embodiment, memory 126 also has diagnosis-related treatment protocols 162, and emergency room triage and/or admission protocols 164 recorded in it. In embodiments having diagnosis-related treatment protocols, these protocols may be structured as a table indicating for each of several diagnoses a most likely progression of a patient from unit to unit, together with an estimated residency time in each unit. For example, as illustrated in Table 5, a patient diagnosed with pneumonia and requiring intubation may be treated according to a protocol that expects that the patient will remain intubated for two to three days before extubation, that the patient will remain in the ICU for a day after extubation, and after extubation will probably be transferred to a stepdown unit until stable on 40% oxygen by mask, which may require another two days before transfer to a general medical-surgical ward. In such an embodiment, if the patient is not yet extubated, the system examines a date of admission and date of the intubation, in order to estimate a length of remaining time before extubation, and adds an expected post-extubation time to determine an estimated date of transfer to the stepdown unit.

In embodiments having diagnosis-related protocols 162 in memory 126, system 100 includes machine readable instructions in memory 126 to lookup diagnoses mined from the EMR of each patient in the diagnosis-related protocols, and to estimate a sequence of units and maximum and minimum stay length in each of those units for the remainder of that patient's stay in the facility, taking into account the patient's current condition and position along the treatment protocol. The estimated sequence and stay lengths for all current patients may in some embodiments then be automatically combined to provide an estimated minimum and maximum bed-count prediction for each unit for each day up to a week in advance to identify impending shortages of any bed type, and the likely need to reactivate closed units or to arrange for relocation of patients to other facilities. In a particular embodiment, a weekday-dependent new-admission prediction is combined with the bed-count prediction for each unit to enhance the minimum and maximum bed-count prediction.

Similarly, an estimated stay length and predicted unit progression can be determined for those with other diagnoses present in the diagnosis-related protocols 162, such as septic shock (Table 5).

TABLE 5
Diagnosis Related Protocol with Unit Stay Estimates

| Diagnosis | Procedure | ICU stay | Stepdown | General | Home |
|---|---|---|---|---|---|
| Severe | Endo- | 2-3 days | FiO2 >40% | Stable | |
| pneumonia | trachial | before | Stay estimate | on | |
| with acute | tube | extubation, | 1-2 days | cannula | |
| respiratory | | ICU stay | To General | Stay | |
| failure | | estimate 3-4 | Med/surg | estimate | |
| requiring | | days | ward. | 2 days | |
| mechanical | | To stepdown | | | |
| ventilator | | | | | |
| Septic Shock | IV | 3 days of | BP stable | Stay | |
| | Vaso- | vasopressor, | 1 day | estimate | |
| | pressor | ICU stay est. | To general | 1 day | |
| | | 4 days, | med/surg | | |
| | | To stepdown | | | |

It should be noted that table-generated automated unit-requirement recommendations as described above are time-sensitive, since some procedures, such as immediate catheterization and revascularization for myocardial infarction, are recommended only within a certain time from onset of symptoms. Similarly, for some diagnoses, mined diagnoses may be used by the system with a diagnosis-related standardized treatment protocol to recommend assignment of a particular patient to a sequence of procedure rooms followed by admission to a particular initial unit.

In an embodiment, memory 126 may also incorporate emergency-room, triage, and admission-department diagnostic protocols 164 that cover a sequence of testing and diagnostic procedures that successively narrow a range of possible diagnoses, and a range of likely initial bed requirements. For example, since both pneumonia and myocardial infarction can cause chest pain and difficulty breathing, a patient arriving with such symptoms may be subjected to a series of diagnostic procedures, such as pulse oximetry, blood draws for troponin testing, chest auscultation, electrocardiography, and chest X-ray, the results of which determine a required treatment protocol and associated unit and bed type for admission, or even whether the patient may be directly discharged from the emergency room. In embodiments having ER, triage, and admission protocols 164, the system has machine-readable instructions in memory 126 to use diagnostic protocols 164 and related treatment protocols 162 to provide a best and a worst case estimated bed-type or unit requirement and unit progression for that patient upon user request. Further, as physical examination is performed and test results become available, the user may request rerunning of the machine-readable instructions in memory 126 that use diagnostic protocols 164 and related treatment protocols 162 to provide a best and a worst case estimated bed-type or unit requirement and unit progression for that patient so that the gap between best and worst case requirements is narrowed.

Thus, there have been shown and described several embodiments having one or more features, which may be combined into a bed utilization prediction and management system. It will be apparent to those skilled in the art, however, that many changes, variations, modifications, and other uses and applications for the product herein described are possible, and also changes, variations, modifications, and other uses and applications which do not depart from the spirit and scope of the invention are deemed to be covered by the invention which is limited only by the claims which follow.

1-18. (canceled)

19. A system for managing beds and tracking patients at a healthcare facility, comprising:
a plurality of patient identification and location transponders;
a location system for identifying a current location of each transponder;
a processor in electronic communication with a non-transitory computer memory; and
electronic instructions stored in the computer memory that, when executed by the processor, performs steps for:
a) periodically accessing electronic health records of a patient maintained by a second processor;
b) mining the patient's electronic health records for each of a procedure-related order, a medication-related order, and a diagnosis;
c) automatically assigning to the patient a first bed type based on an assessment of the mined records;
d) assigning a particular bed of the first bed type to the patient; and
e) outputting an alert if the patient identification and location transponder indicates that the patient is more than a predetermined distance away from the assigned bed and is not in one of a plurality of designated areas commonly used by patients temporarily; the designated areas including a physical therapy room, an X-ray room, and an operating room;
wherein assessment of the procedure-related order and the medication-related order respectively comprises the step of accessing in the computer memory a procedure-order to bed-type table and a medication-order to bed-type table;
wherein assessment of the diagnosis comprises the steps of: (i) accessing a diagnosis to bed-type table located in the computer memory; and (ii) determining a current position of the patient along a diagnosis-related treatment protocol, the diagnosis-related treatment protocol indicating a first estimated duration for which the bed of the first type is assigned to the patient and a second estimated duration for which a bed of a second type is assigned to the patient.

20. The bed management and patient tracking system of claim 19, wherein the diagnosis is that one of a plurality of diagnoses that restricts the patient to the bed type that is most restrictive.

21. The bed management and patient tracking system of claim 19 wherein the first bed type is one that provides for cardiac monitoring services and the second bed type is one that does not provide for cardiac monitoring services.

22. The bed management and patient tracking system of claim 21 wherein the patient identification and location transponder is configured to be worn on a wrist of the patient.

23. The bed management and patient tracking system of claim 19 wherein the electronic instructions when executed by the processor further perform steps for displaying a lab result of the patient.

24. The bed management and patient tracking system of claim 19 wherein the electronic instructions when executed by the processor further perform steps for displaying for a user a name and location of the patient only if the user has a second level of authorization that is higher than a first level of authorization.

25. The bed management and patient tracking system of claim 19 wherein the electronic instructions when executed by the processor further perform steps for preparing for a housekeeping department a prioritized list of beds in need of cleaning.

26. A system for managing beds and tracking patients at a healthcare facility, comprising:
a plurality of patient identification and location transponders;
a location system for identifying a current location of each transponder;
a processor in electronic communication with a non-transitory computer memory; and
electronic instructions stored in the computer memory that, when executed by the processor, performs steps for:
a) mining electronic health records of a patient for a diagnosis;
b) automatically assigning to the patient a first bed type based on an assessment of the diagnosis; and
c) assigning a particular bed of the first bed type to the patient;
wherein assessment of the diagnosis comprises the steps of: (i) accessing a diagnosis to bed-type table located in the computer memory; and (ii) determining a current position of the patient along a diagnosis-related treatment protocol, the diagnosis-related treatment protocol indicating a first estimated duration for which the bed of the first type is assigned to the patient and a second estimated duration for which a bed of a second type is assigned to the patient.

27. The bed management and patient tracking system of claim 26, wherein the diagnosis is that one of a plurality of diagnoses that restricts the patient to the bed type that is most restrictive.

28. The bed management and patient tracking system of claim 26 wherein the patient identification and location transponder is configured to be worn on a wrist of the patient.

29. The bed management and patient tracking system of claim 26 wherein the electronic instructions when executed by the processor further perform steps for displaying a lab result of the patient.

30. The bed management and patient tracking system of claim 26 wherein the electronic instructions when executed by the processor further perform steps for displaying for a user a name and location of the patient only if the user has a second level of authorization that is higher than a first level of authorization.

31. The bed management and patient tracking system of claim 26 wherein the electronic instructions when executed by the processor further perform steps for preparing for a housekeeping department a prioritized list of beds in need of cleaning.

32. A system for managing beds and tracking patients at a healthcare facility, comprising:
a plurality of patient identification and location transponders;
a location system for identifying a current location of each transponder;
a processor in electronic communication with a non-transitory computer memory; and
electronic instructions stored in the computer memory that, when executed by the processor, performs steps for:
a) periodically accessing electronic health records of a patient maintained by a second processor;
b) mining the patient's electronic health records for at least one of a medication-related order and a diagnosis;
c) automatically assigning to the patient for a first period a first bed type based on an assessment of the mined records;
d) assigning a particular bed of the first bed type to the patient; and
e) outputting an alert if the patient identification and location transponder indicates that the patient is more than a predetermined distance away from the assigned bed and is not in one of a plurality of designated areas commonly used by patients temporarily;
wherein, when the assessment of the medication-related order indicates that the patient is prescribed a certain single-dose medication, the first period corresponds to the time it takes for the single-dose medication to wear off;
wherein, assessment of the diagnosis comprises steps for determining a current position of the patient along a diagnosis-related treatment protocol.

33. The bed management and patient tracking system of claim 32, wherein the computer memory comprises a medication-order to bed-type table and a diagnosis to bed-type table.

34. The bed management and patient tracking system of claim 32, wherein the diagnosis is that one of a plurality of diagnoses that restricts the patient to the bed type that is most restrictive.

35. The bed management and patient tracking system of claim 32 wherein the patient identification and location transponder is configured to be worn on a wrist of the patient.

36. The bed management and patient tracking system of claim 32 wherein the electronic instructions when executed by the processor further perform steps for displaying an X-ray of the patient.

37. The bed management and patient tracking system of claim 32 wherein the electronic instructions when executed by the processor further perform steps for displaying for a user a name and location of the patient only if the user has a second level of authorization that is higher than a first level of authorization.
